(19) United States
(12) Patent Application Publication
(10) Pub. No.: US 2025/0137569 A1
(43) Pub. Date: May 1, 2025

(54) OUTER SHEATH REPAIR SYSTEM AND RELATED METHODS FOR FLEXIBLE PIPE

(71) Applicant: ExxonMobil Technology and Engineering Company, Spring, TX (US)

(72) Inventors: Krassimir I. DOYNOV, Houston, TX (US); Brandon L. HENNEKE, Houston, TX (US); Rachel E. IWICKI, Houston, TX (US)

(21) Appl. No.: 18/730,531

(22) PCT Filed: Jan. 20, 2023
(86) PCT No.: PCT/US2023/060981

§ 371 Date: Jul. 19, 2024

Related U.S. Application Data
(60) Provisional application No. 63/267,170, filed on Jan. 26, 2022.

(51) Int. Cl. F16L 55/168; B29C 63/10; F16L 11/08

(52) U.S. Cl. CPC F16L 55/1686; B29C 63/105; F16L 11/083

(57) ABSTRACT

Methods of repairing a flexible pipe include securing a composite tape to a surface of an outer sheath using a structural adhesive, the composite tape forming a composite repair over a rupture in the outer sheath; and immobilizing the composite tape at the ends of the wrapped portion with a securing device. Methods of repairing a flexible pipe include applying a structural adhesive to a composite tape; and securing to composite tape to an outer sheath of the flexible pipe, the composite tape forming a composite repair over a rupture in the outer sheath. Systems include a flexible pipe; a composite repair sealing a rupture in an outer sheath of the flexible pipe, the composite repair including a composite tape wrapped helically around the flexible pipe, and a structural adhesive securing the composite tape to the flexible pipe.

### CROSS-REFERENCE TO RELATED APPLICATION

This application is the U.S. National Stage Application of the International Application No. PCT/US2023/060981, entitled “OUTER SHEATH REPAIR SYSTEM AND RELATED METHODS FOR FLEXIBLE PIPE,” filed on Jan. 20, 2023, the disclosure of which is hereby incorporated by reference in its entirety, which claims the benefit of U.S. Provisional Application Ser. No. 63/267,170, entitled “Outer Sheath Repair System and Related Methods for Flexible Pipe,” filed Jan. 26, 2022, the disclosure of which is hereby incorporated by reference in its entirety.

### FIELD OF THE INVENTION

The presently disclosed subject matter relates to methods and systems for repairing flexible pipe outer sheaths with compromised structural integrity.

### BACKGROUND OF THE INVENTION

In a number of hydrocarbon production operations, flexible pipes are used widely for the transport of oil and gas, on land and in marine applications, to surface installations where the produced fluids are refined or forwarded for further processing. Flexible pipes may include an inner liner or non-metallic sheath to ensure fluid containment of the hydrocarbons transported in the pipe. The inner liner may also be surrounded by one or more intermediate layers that serve a number of functions, including resistance to hydrostatic collapse, pressure, axial forces, friction and thermal conductivity. The resistance to hydrostatic collapse and pressure is provided by separate layers composed of interlocked helically wound wires. The resistance to axial forces is provided by separate layers composed of non-interlocking helically wound wires. The flexible pipe may also include a non-metallic outer sheath forming a protective barrier against the external pipe-surrounding environment. The space enclosed between two concentric non-metallic sheaths (sealed in both pipe end terminations to provide fluid tightness) is termed pipe annulus.

Adjacent layers of the flexible pipe are generally “un-bonded” and do not form interlayer connections. Adjacent wires within a layer of the flexible pipe are also “un-bonded” and do not form interwire connections. The lack of interlayer and interwire connections allows for relative layer and wire movement, ensuring enhanced flexibility and durability. Un-bonded flexible pipes allow gas permeation from the pipe bore to the annulus through the inner sheath due to pressure and temperature differentials. For flexible risers hung from a fixed or floating platform, gasses accumulated in the annulus are released through vent ports built into the end fitting terminations of the flexible riser.

Damage to the outer sheath of the flexible pipe can occur through various failure modes, including annulus overpressure from blocked vent ports, aging and mechanical fatigue, impact damage, and the like. Rupturing of the outer sheath can lead to cascading damage to underlying structural layers, such as permitting oxygen and other corrosive elements to contact and degrade reinforcement layers. Without efficient mitigation, damage to the outer sheath can ultimately lead to loss of riser containment, along with reduced production, environmental pollution, and health hazards for personnel. Flexible pipe outer sheath repair following a rupture typically includes the use of various rigid metal clamps with inner liners that are fastened around the damaged outer sheath. Clamps can impede the movement and flexibility of the pipe layers, which induces additional stress as the thickness of the pipe varies during cyclic loading. Because the clamp material is much stiffer than the outer sheath, additional cracks and ruptures can propagate near the site of repair of aged outer sheaths.

### SUMMARY OF THE INVENTION

The presently disclosed subject matter relates to methods and systems for repairing flexible pipe.

In one aspect, methods of repairing a flexible pipe include securing a composite tape to a surface of an outer sheath using a structural adhesive, the composite tape forming a composite repair over a rupture in the outer sheath; and immobilizing the composite tape at the ends of the wrapped portion with a securing device.

In another aspect, methods of repairing a flexible pipe include applying a structural adhesive to a composite tape; and securing to composite tape to an outer sheath of the flexible pipe, the composite tape forming a composite repair over a rupture in the outer sheath.

In another aspect, systems include a flexible pipe; a composite repair sealing a rupture in an outer sheath of the flexible pipe, the composite repair including a composite tape wrapped helically around the flexible pipe, and a structural adhesive securing the composite tape to the 30 flexible pipe.

### BRIEF DESCRIPTION OF THE DRAWINGS

FIG. 1 is a diagram illustrating the basic structure of a flexible pipe in accordance with the present disclosure.

FIG. 2 is a diagram showing a composite repair installed on a flexible pipe in accordance with the present disclosure.

FIGS. 3A-3C are diagrams illustrating potential methods of wrapping a composite tape to form a composite repair in accordance with the present disclosure.

### DETAILED DESCRIPTION OF THE INVENTION

The presently disclosed subject matter relates to methods and systems for repairing flexible pipe. Methods disclosed herein may include forming a composite repair to repair a rupture on the outer sheath of a flexible pipe using a structural adhesive to secure one or more layers of a composite tape. Systems disclosed herein may include a flexible pipe having a composite repair thereon, the composite repair including a composite tape affixed using a structural adhesive.

Methods of repairing flexible pipes disclosed herein include the formation of a composite repair over an identified structural weakness or rupture of the outer sheath that can restore or improve the integrity of the repaired region to initial flexible pipe specification to withstand annulus internal pressure up to about 2 bar or more. Composite repairs of the present disclosure may have a number of advantages, such as enabling the repair of breached outer sheaths with a material having stiffness comparable to that of the pipe outer sheath that minimizes chain-reaction failures; resisting a pressure build up inside the flexible pipe annulus that is not less than the maximum pressure the intact outer sheath can resist without bursting; being lower in cost and less labor-intensive than comparative methods using commercially available clamps. Methods disclosed herein may also be used to repair a flexible pipe in situ, reducing rig down time without interrupting production.

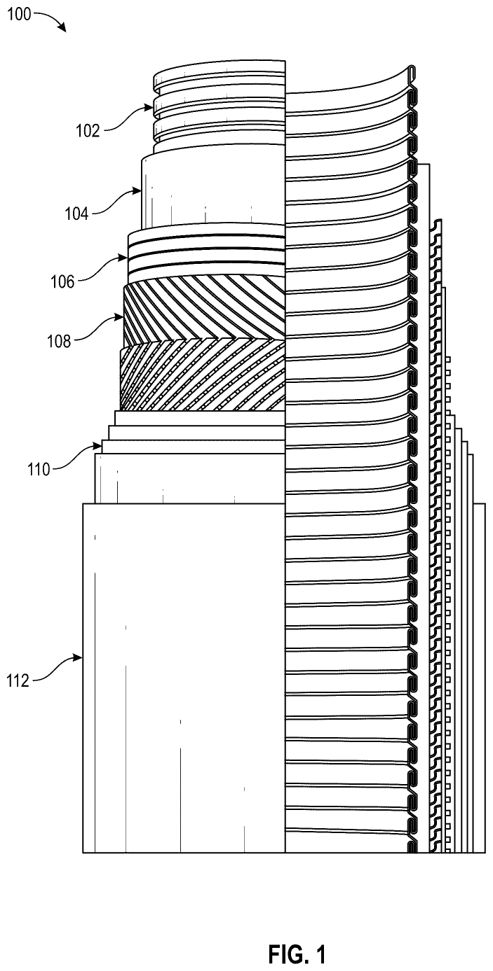

With respect to FIG. 1, a detailed example of the layered structure of an embodiment of a flexible pipe is shown. A flexible pipe 100 may include a number of interior layers, including a carcass 102, inner sheath 104, anti-wear linings 106, armor layers 108, and pressure linings 110, which are sealed, covered, and/or protected by an outer sheath 112. Although FIG. 1 depicts a relatively simple flexible pipe structure 100, those skilled in the art will appreciate that a flexible pipe may include additional and/or different layers, including liners, hoop-stress reinforcement layers, anti-wear layers, lubricating layers, tensile reinforcement layers, anti-extrusion layers, membranes, and the like.

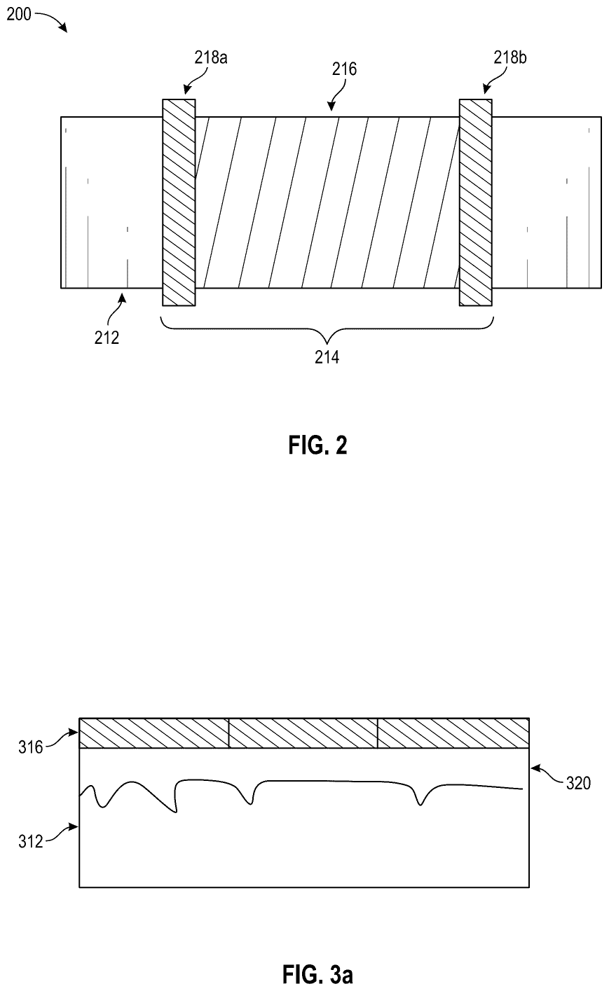

In the field of operation, flexible pipe 100 is exposed to a variety of environmental and mechanical stresses, which can create aging, fatigue and damage to the outer sheath 112 in the form of ruptures and other failure modes that can result in uncontrolled annulus communication with the external environment. When a rupture in the outer sheath 112 is detected, the application of a structural adhesive and a composite tape form a composite repair on the outer sheath of a flexible pipe. FIG. 2 shows an example in which a flexible pipe 200 having damage to outer sheath 212 is repaired through the application of a composite repair 214. Damage to the outer sheath 212 is mitigated through the application of a composite tape 216 that is bonded to the outer sheath 212 by a structural adhesive that fills and seals the damaged regions and forms a leak-tight seal.

To build the composite repair 214, the structural adhesive is applied to the surface of the outer sheath and/or the composite tape, and the composite tape is wrapped over the adhesive with applied pressure. After wrapping is completed, the structural adhesive is allowed to cure to form inter-laminar bonds between the outer sheath and the one or more layers of composite tape.

Structural adhesives disclosed herein may be provided in a film, fluid, solid, gel, and/or powder state, and may be uncured or partially cured at the time of application to the composite tape or outer sheath. Structural adhesives may have a curing and/or operating temperature range of about 4° C. to about 50° C. In some embodiments, repair methods may utilize a combination of structural adhesives having complementary functions. For example, particularly in submerged systems, a structural adhesive may include a first adhesive that provides initial tack to facilitate composite tape installation, while a second adhesive cures and forms the durable final bond.

Suitable structural adhesives may include acrylic polymer and copolymer adhesives, polybutylmethacrylate, polyacrylonitrile, acrylonitrile-styrene copolymer, ethylene-methyl methacrylate copolymer, polyamide, polyimide, polyether, polyetheretherketone, polyphenylene sulfide, polyvinylidene halide, vinyl halide polymer, vinyl halide copolymer, polyoxymethylene, polyvinyl ketone, polyvinyl ether, polyvinyl methyl ether, polyvinyl aromatic, epoxy resins, polyurethane, silicones, rubber-based adhesives, and the like, and combinations thereof.

The composite tape 216 provides long term resistance to creep, resists annulus pressure, and extends the service life of the flexible pipe, including in applications requiring water-tight outer sheath repairs, such as subsea and power cables. Composite tape 216 may include a structure having a reinforcing fiber component embedded in a polymer matrix. Composite tapes may include a fiber component that may include glass fiber, aramid, carbon, high strength steel fiber, polyester aromatic polyesters, polyoxazole, e-glass, polyamide, polypropylene, composite fabrics such as dyneema and spectra, and/or any other fiber used in composite structural materials. The polymer matrix may include medium and high density polyethylenes, thermoplastic polyurethanes, polyamides, polyvinylidene fluoride, thermoplastic elastomers, ethylene-vinyl acetates, ethylene acrylic acid copolymers, polypropylenes, epoxy resins, polyesters, vinyl esters, and the like.

Ends of the composite tape 216 may be immobilized to eliminate or minimize de-lamination during operation by one or more securing devices 218a,b. Securing devices 218a,b may extend along the pipe diameter completely or partially to contact and hold the composite tape 216 in place. Securing devices may be mechanical such as straps, soft clamps, pipe clamps, caterpillar clamps, clips, ties, bands, o-rings, ligatures, and the like. In some embodiments, securing devices 218a,b may be chemical such as an adhesive used alone or in addition to the physical securing device (e.g., clamp, band, etc.) that is applied under and/or over the composite tape 216 ends. Chemical securing devices 218a,b may include any of the structural adhesives listed above and may be the same or different than the structural adhesive applied to the outer sheath 212 and/or composite tape 216.

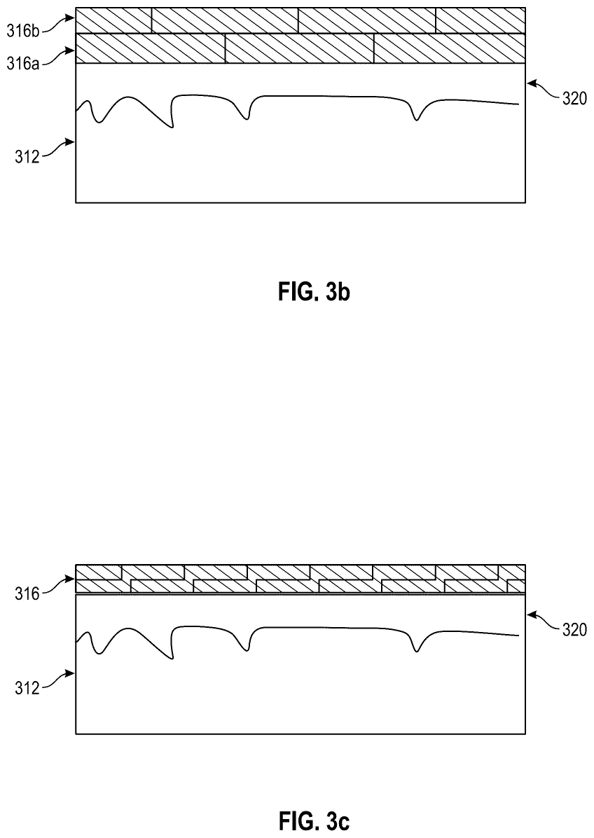

The configuration of composite tape 216 over the outer sheath 212 of the flexible pipe 200 is not considered particularly limited as long as the resulting composite repair creates a seal that mitigates the underlying rupture or damage. As shown in FIGS. 3A-C, the composite tape may be applied in a number of variations, which may include varying the direction of wrapping, the helix angle with respect to the flexible pipe central axis, percentage of overlap between adjacent wraps, number of wrapping layers, and the like. Composite tape may be wound at any suitable angle to seal a damaged or ruptured outer sheath of a flexible pipe. In some embodiments, the composite tape may be wound at a helix angle of may be between about 25° to about 60°, relative to the center axis of the pipe.

In FIG. 3A, an example is presented in which a composite repair is formed by applying a single layer of composite tape 316 to an outer sheath 312 using structural adhesive 320. Single layer composite repairs may be appropriate where composite tape 316 is wide enough to cover the rupture in outer sheath 312 and/or where reinforcement (as opposed to stopping fluid loss, for example) is the primary function. In FIG. 3B, a multi-layered configuration is shown in which a first layer 316a is applied to the outer sheath 312 by structural adhesive 320. A second layer 316b is then applied to first layer 316a to enhance the resistance to leakage between the seams created by adjacent wraps of composite tape in the first layer 316a. The overlap between layers 316a and 316b may be by any amount sufficient to seal the underlying outer sheath 312. An about 50:50 overlap of top layer 316b over the seam between adjacent wraps of lower layer 316a is shown in FIG. 3B (50% of a wrap from the upper layer contacts each side of the seam), however, all values are within the scope of this disclosure, such as about 0:100, about 10:90, about 20:80, and the like.

Composite repairs may also include overlapping configurations in which one or more layers have successive wraps that overlap a portion of the edge of a preceding wrap by some amount. As shown in FIG. 3C, overlapping configurations may include arranging composite tape 316 in a single overlapping layer secured to outer sheath 312 by structural adhesive 320. Overlap between successive wraps may be by any amount sufficient to seal the outer sheath, such as about 50%, about 40%, or about 30%.

In multilayer and overlapping configurations, including those shown in FIG. 3B and FIG. 3C, structural adhesive 320 may be applied to all or a subset of layers 316 (similarly 316a,b) to promote inter-laminar bonding. Further, while a number of examples are presented, it is envisioned that composite tape may be arranged to form a composite repair having three, four, or more sub-layers without deviating from the scope of the present disclosure. Multilayer configurations may also include one or more layers in an overlapping configuration.

Composite repairs disclosed herein may also include the installation of one or more vent ports that enable pressurized gases and fluids to be released from the annular space between the layers of the flexible pipe. For example, additional vents installed and wrapped in composite tape may compensate for blocked vent ports in other sections of the flexible pipe, such as end fitting terminations.

Composite repairs may also include additional accessories such as UV protective coatings or jackets that reduce mechanical damage from elemental exposure.

Repair of a flexible pipe according to methods disclosed herein may begin once an outer sheath weakness or rupture is detected by any suitable method in the art to restore or improve the integrity of the repaired region to initial flexible pipe specification. Methods may include identifying the location of a rupture and, in some cases, preparing the area by cleaning and/or roughening the surface to aid application of the composite repair.

Methods disclosed herein may include the preparation of the surface by removal of any debris or damaged outer sheath. Prior to application of a composite repair to the outer sheath of a flexible pipe, contact surfaces may be cleaned and/or abraded to enhance bonding during the repair procedure. The abrasion may be made by a physical or chemical process that removes residues and particulates that may impede application of the structural adhesive and/or composite tape. Physical abrasion may be accomplished by sanding, grinding, filing, compressed air, or other physical abrasion tools or methods. Chemical abrasion may be accomplished by solvents, surfactants, or other cleaning agents.

Methods of forming a composite repair disclosed herein may include securing a composite tape to the outer sheath using a structural adhesive, the composite tape forming a composite repair over a rupture in the outer sheath, and optionally immobilizing the composite tape at the ends of the wrapped portion with a securing device. Other methods of repairing a flexible pipe may include applying a structural adhesive to a composite tape, securing the composite tape to the outer sheath of the flexible pipe, and optionally immobilizing the composite tape at the ends of the wrapped portion with a securing device.

Methods may also include the formation of multilayer wrap configurations of composite tape in which structural adhesive forms inter-laminar bonds between one or more layers of the composite repair, such as between the outer sheath and the composite tape, and between successive layers of composite tape. Multilayer configurations may be formed in some embodiments by wrapping a first layer of the composite tape helically around the flexible pipe, the edges of the composite tape forming a first layer having abutting wraps of composite tape, followed by wrapping the composite tape helically around the first layer and forming a second layer having abutting wraps.

Composite repairs may also include overlapping configurations in which one or more layers have successive wraps that overlap a portion of the edge of a preceding wrap by some amount. Overlapping configurations may be formed by wrapping a single layer helically around the flexible pipe, where the edges of the composite tape overlap by at least 50%, at least 40%, or at least 30%. Overlapping may be applied to a single layer, a single layer in a multilayer configuration, or multiple layers in a multilayer configuration.

Embodiments disclosed herein include the following.
A. Methods of repairing a flexible pipe, comprising: securing a composite tape to a surface of an outer sheath using a structural adhesive, the composite tape forming a composite repair over a rupture in the outer sheath; and immobilizing the composite tape at the ends of the wrapped portion with a securing device.
B. Methods of repairing a flexible pipe, comprising: applying a structural adhesive to a composite tape; and securing to composite tape to an outer sheath of the flexible pipe, the composite tape forming a composite repair over a rupture in the outer sheath.
C. Systems comprising: a flexible pipe; a composite repair sealing a rupture in an outer sheath of the flexible pipe, the composite repair comprising a composite tape wrapped helically around the flexible pipe, and a structural adhesive securing the composite tape to the flexible pipe.

Embodiments A, B, and C may have one or more of the following additional elements in any combination.

Element 1: wherein the structural adhesive is applied to a surface of the outer sheath prior to securing the composite tape to the outer sheath.

Element 2: wherein the structural adhesive is applied to the composite tape prior to securing the composite tape to the outer sheath.

Element 3: wherein the structural adhesive comprises the structural adhesive.

Element 4: wherein the structural adhesive comprises one or more of acrylic polymer and copolymer adhesives, polybutylmethacrylate, polyacrylonitrile, acrylonitrile-styrene copolymer, ethylene-methyl methacrylate copolymer, polyamide, polyimide, polyether, polyetheretherketone, polyphenylene sulfide, polyvinylidene halide, vinyl halide polymer, vinyl halide copolymer, polyoxymethylene, polyvinyl ketone, polyvinyl ether, polyvinyl methyl ether, polyvinyl aromatic, epoxy resins, polyurethane, silicones, and rubber-based adhesives.

Element 5: wherein the composite tape comprises a fiber component selected from one or more of glass fiber, aramid, carbon, high strength steel fiber, polyester aromatic polyesters, polyoxazole, e-glass, polyamide, polypropylene, and composite fabrics.

Element 6: wherein the composite tape comprises a polymer matrix selected from one or more of include medium and high density polyethylenes, thermoplastic polyurethanes, polyamides, thermoplastic elastomers, ethylene-vinyl acetates, ethylene acrylic acid copolymers, and polypropylenes.

Element 7: wherein securing comprises wrapping a layer of the composite tape helically around the flexible pipe, the edges of the composite tape abutting and forming a single layer.

Element 8: wherein securing comprises wrapping a layer of the composite tape helically around the flexible pipe, the edges of the composite tape overlapping by at least 30%.

Element 9: wherein securing comprises wrapping a first layer of the composite tape helically around the flexible pipe, the edges of the composite tape forming first layer abutting, and wrapping a second layer of the composite tape helically around the first layer.

Element 10: wherein second layer is configured with an about 50:50 overlap over a seam between adjacent wraps of the first layer.

Element 11: wherein one or more ends of the composite repair are immobilized with a securing device.

Element 12: wherein the securing device is one or more selected from straps, soft clamps, pipe clamps, caterpillar clamps, clips, ties, bands, o-rings, ligatures, and adhesive.

Element 13: wherein the surface of the outer sheath is prepared prior to securing the composite tape by one or more of cleaning and abrading.

Element 14: wherein sealing further comprises installing a vent port.

Element 15: wherein securing comprises wrapping a first layer of the composite tape helically around the flexible pipe, the edges of the composite tape forming first layer abutting, and wrapping a second layer of the composite tape helically around the first layer.

Element 16: wherein securing comprises wrapping a layer of the composite tape helically around the flexible pipe, the edges of the composite tape overlapping by at least 50%.

Element 17: the system further comprising one or more securing devices securing an end of the composite tape to the flexible pipe.

By way of non-limiting example, exemplary combinations applicable to A include, but are not limited to, 1 and any one or more of 2 to 14; 2 and any one or more of 1 and 3 to 14; 3 and any one or more of 1 to 2 and 4 to 14; 4 and any one or more of 1 to 3 and 5 to 14; 5 and any one or more of 1 to 4 and 6 to 14; 6 and any one or more of 1 to 5 and 7 to 14; 7 and any one or more of 1 to 6 and 8 to 14; 8 and any one or more of 1 to 7 and 9 to 14; 9 and any one or more of 1 to 8 and 10 to 14; 10 and any one or more of 1 to 9 and 11 to 14; 11 and any one or more of 1 to 10 and 12 to 14; 12 and any one or more of 1 to 11 and 13 to 14; 13 and any one or more of 1 to 12 and 14; and 14 and any one or more of 1 to 13. Exemplary combinations applicable to B include, but are not limited to, any one or more of 15 and 16. Exemplary combinations applicable to C include, but are not limited to, 17.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A method of repairing a flexible pipe, comprising:
securing a composite tape to a surface of an outer sheath using a structural adhesive, the composite tape forming a composite repair over a rupture in the outer sheath; and
immobilizing the composite tape at the ends of the wrapped portion with a securing device.

2. The method of claim 1, wherein the structural adhesive is applied to a surface of the outer sheath prior to securing the composite tape to the outer sheath.

3. The method of claim 1, wherein the structural adhesive is applied to the composite tape prior to securing the composite tape to the outer sheath.

4. The method of claim 1, wherein the structural adhesive comprises the structural adhesive.

5. The method of claim 1, wherein the structural adhesive comprises one or more of acrylic polymer and copolymer adhesives, polybutylmethacrylate, polyacrylonitrile, acrylonitrile-styrene copolymer, ethylene-methyl methacrylate copolymer, polyamide, polyimide, polyether, polyetheretherketone, polyphenylene sulfide, polyvinylidene halide, vinyl halide polymer, vinyl halide copolymer, polyoxymethylene, polyvinyl ketone, polyvinyl ether, polyvinyl methyl ether, polyvinyl aromatic, epoxy resins, polyurethane, silicones, and rubber-based adhesives.

6. The method of claim 1, wherein the composite tape comprises a fiber component selected from one or more of glass fiber, aramid, carbon, high strength steel fiber, polyester aromatic polyesters, polyoxazole, e-glass, polyamide, polypropylene, and composite fabrics.

7. The method of claim 1, wherein the composite tape comprises a polymer matrix selected from one or more of include medium and high density polyethylenes, thermoplastic polyurethanes, polyamides, thermoplastic elastomers, ethylene-vinyl acetates, ethylene acrylic acid copolymers, and polypropylenes.

8. The method of claim 1, wherein securing comprises wrapping a layer of the composite tape helically around the flexible pipe, the edges of the composite tape abutting and forming a single layer.

9. The method of claim 1, wherein securing comprises wrapping a layer of the composite tape helically around the flexible pipe, the edges of the composite tape overlapping by at least 30%.

10. The method of claim 1, wherein securing comprises wrapping a first layer of the composite tape helically around the flexible pipe, the edges of the composite tape forming first layer abutting, and wrapping a second layer of the composite tape helically around the first layer.

11. The method of claim 10, wherein second layer is configured with an about 50:50 overlap over a seam between adjacent wraps of the first layer.

12. The method of claim 1, wherein one or more ends of the composite repair are immobilized with a securing device.

13. The method of claim 12, wherein the securing device is one or more selected from straps, soft clamps, pipe clamps, caterpillar clamps, clips, ties, bands, o-rings, ligatures, and adhesive.

14. The method of claim 1, wherein the surface of the outer sheath is prepared prior to securing the composite tape by one or more of cleaning and abrading.

15. The method of claim 1, wherein sealing further comprises installing a vent port.

16. A method of repairing a flexible pipe, comprising:
applying a structural adhesive to a composite tape; and
securing to composite tape to an outer sheath of the flexible pipe, the composite tape forming a composite repair over a rupture in the outer sheath.

17. The method of claim 16, wherein securing comprises wrapping a first layer of the composite tape helically around the flexible pipe, the edges of the composite tape forming first layer abutting, and wrapping a second layer of the composite tape helically around the first layer.

18. The method of claim 16, wherein securing comprises wrapping a layer of the composite tape helically around the flexible pipe, the edges of the composite tape overlapping by at least 50%.

19. A system, comprising:
a flexible pipe;
a composite repair sealing a rupture in an outer sheath of the flexible pipe, the composite repair comprising a composite tape wrapped helically around the flexible pipe, and a structural adhesive securing the composite tape to the flexible pipe.

20. The system of claim 19, further comprising one or more securing devices securing an end of the composite tape to the flexible pipe.
